(19) United States
(12) Patent Application Publication
(10) Pub. No.: US 2026/0109872 A1
(43) Pub. Date: Apr. 23, 2026

(54) Ink Jet Ink Composition And Ink Jet Recording Method

(71) Applicant: SEIKO EPSON CORPORATION, Tokyo (JP)

(72) Inventors: Kohei ISHIDA, Matsumoto (JP); Tomohiro ARUGA, Matsumoto (JP)

(21) Appl. No.: 19/362,615

(22) Filed: Oct. 20, 2025

(30) Foreign Application Priority Data
Oct. 21, 2024 (JP) 2024-184914

(51) Int. Cl. C09D 11/30; C09D 11/033; B41J 2/165

(52) U.S. Cl. CPC C09D 11/30; C09D 11/033; B41J 2/16505

(57) ABSTRACT

An ink jet ink composition according to an embodiment of the present disclosure is an ink jet ink composition including a coloring material, an organic solvent, and water, in which the organic solvent is one or more kinds selected from triethylene glycol monobutyl ether, tetraethylene glycol monobutyl ether, N-hydroxyethyl-2-pyrrolidone, and ε-caprolactam.

The present application is based on, and claims priority from JP Application Serial Number 2024-184914, filed October 21, 2024, the disclosure of which is hereby incorporated by reference herein in its entirety.

### BACKGROUND

### 1. Technical Field

The present disclosure relates to an ink jet ink composition and an ink jet recording method.

### 2. Related Art

Ink jet recording methods can record high-definition images with a relatively simple device, and achieve rapid development in various fields. Among them, a solvent used in an ink composition has been studied so as to be suitable for an ink jet recording method.

For example, JP-A-2024-048626 describes solvent-based ink jet ink compositions containing tetraethylene glycol monobutyl ether as an organic solvent.

However, there is a problem in achieving both clogging recoverability and continuous ejection stability.

### SUMMARY

An aspect of the ink jet ink composition according to the present disclosure is an ink jet ink composition containing a coloring material, an organic solvent, and water, in which the organic solvent contains one or more kinds selected from triethylene glycol monobutyl ether, tetraethylene glycol monobutyl ether, N-hydroxyethyl-2-pyrrolidone, and ε-caprolactam.

One aspect of the ink jet recording method according to the present disclosure includes ejecting the ink jet ink composition of the above-described one aspect from an ink jet head and attaching the ink jet ink composition to a recording medium.

### BRIEF DESCRIPTION OF THE DRAWINGS

FIG. 1 is Table 1 showing composition examples of ink jet ink compositions according to Examples and evaluation results thereof.

FIG. 2 is Table 2 showing composition examples of ink jet ink compositions according to Examples and Comparative Examples, and evaluation results thereof.

### DESCRIPTION OF EMBODIMENTS

Embodiments of the present disclosure will be described below. The embodiments described below describe examples of the present disclosure. The present disclosure is not limited to the following embodiments and includes various modifications made without changing the gist of the present disclosure. It should be noted that not all of the configurations described below are essential configurations of the present disclosure.

In the present specification, a numerical range indicated by using "to" means a range including numerical values described before and after "to" as a lower limit value and an upper limit value.

In the present specification, "(meth)acrylic" means acrylic or methacrylic, and "(meth)acrylate" means acrylate or methacrylate.

### 1. Ink jet ink composition

An ink jet ink composition according to an embodiment of the present disclosure is an ink jet ink composition containing a coloring material, an organic solvent, and water, in which the organic solvent contains one or more kinds selected from triethylene glycol monobutyl ether, tetraethylene glycol monobutyl ether, N-hydroxyethyl-2-pyrrolidone, and ε-caprolactam.

Triethylene glycol monobutyl ether (hereinafter, also referred to as "BTG") has an alkoxy group and thus has relatively high hydrophobicity. Therefore, by containing BTG, the solubility and dispersibility of the coloring material in the aqueous ink jet ink composition can be improved, and occurrence of precipitation or solidification of the coloring material can be suppressed. As a result, clogging recoverability of the aqueous ink jet ink composition can be improved.

On the other hand, BTG has a property of easily increasing the viscosity of an aqueous ink jet ink composition. When the viscosity of the ink jet ink composition is increased, ejection from the ink jet head may become unstable.

As a result of extensive studies by the present inventors, it has been found that ejection stability of the ink jet ink composition can be improved by containing one or more kinds selected from tetraethylene glycol monobutyl ether (hereinafter also referred to as "BTeG"), N-hydroxyethyl-2-pyrrolidone, and ε-caprolactam in addition to BTG.

This is presumed to be because the coexistence of BTG and BTeG can improve the solubility and dispersibility of the coloring material while reducing an increase in viscosity due to BTG. In addition, it is presumed that by containing one or more kinds selected from N-hydroxyethyl-2-pyrrolidone and ε-caprolactam, the high hydrophobicity due to BTG and BTeG is moderated, the balance between hydrophilicity and hydrophobicity in aqueous ink components is improved, and continuous ejection stability is also excellent.

Therefore, according to the ink jet ink composition according to the present embodiment, it is possible to make the solubility and dispersibility of the coloring material favorable, to provide excellent clogging recoverability, and to provide excellent continuous ejection stability.

Components contained in the ink jet ink composition according to the embodiment will be described below.

### 1. 1. Coloring material

The ink jet ink composition according to the present embodiment contains a coloring material. Examples of the coloring material include a dye and a pigment.

### 1. 1. 1. Dye

Examples of the dye include a water-soluble dye and a disperse dye.

In the ink jet ink composition according to the present embodiment, the coloring material preferably includes a water-soluble dye. In the case where the coloring material contains a water-soluble dye, precipitation and solidification of the coloring material are less likely to occur, and the balance between hydrophilicity and hydrophobicity in the ink components is more likely to be improved. Therefore, clogging recoverability and continuous ejection stability tend to be further improved.

As the water-soluble dye, various water-soluble dyes can be used, and examples thereof include an acid dye, a direct dye, and a reactive dye. In the ink jet ink composition according to the present embodiment, the water-soluble dye is preferably one or more kinds selected from an acid dye, a direct dye, and a reactive dye. When the water-soluble dye is one or more kinds selected from these, precipitation and solidification of the coloring material are less likely to occur, and the balance between hydrophilicity and hydrophobicity in the ink components is more likely to be improved. Therefore, clogging recoverability and continuous ejection stability tend to be further improved.

Examples of the acid dye include C.I. Acid Red 1, 6, 8, 9, 13, 14, 18, 19, 24, 26, 27, 28, 32, 35, 37, 42, 51, 52, 57, 62, 75, 77, 80, 82, 83, 85, 87, 88, 89, 92, 94, 95, 97, 106, 111, 114, 115, 117, 118, 119, 127, 128, 129, 130, 131, 133, 134, 138, 143, 145, 149, 151, 154, 155, 158, 168, 180, 183, 184, 186, 194, 198, 199, 209, 211, 215, 216, 217, 219, 249, 252, 254, 256, 257, 260, 261, 262, 263, 265, 266, 274, 276, 282, 283, 289, 299, 301, 303, 305, 315, 318, 320, 321, 322, 336, 337, 361, 396, and 397;

C.I. Acid Violet 5, 7, 11, 15, 31, 34, 35, 41, 43, 47, 48, 49, 51, 54, 66, 68, 75, 78, 90, 97, 103, 106, and 126;

C.I. Acid Yellow 1, 3, 7, 11, 17, 19, 23, 25, 29, 36, 38, 39, 40, 42, 44, 49, 50, 59, 61, 64, 70, 72, 75, 76, 78, 79, 98, 99, 110, 111, 112, 114, 116, 118, 119, 127, 128, 131, 135, 141, 142, 143, 151, 159, 161, 162, 163, 164, 165, 169, 174, 184, 190, 195, 196, 197, 199, 207, 218, 219, 222, 227, and 246;

C.I. Acid Blue 1, 7, 9, 15, 22, 23, 25, 27, 29, 40, 41, 43, 45, 49, 54, 59, 60, 62, 72, 74, 76, 78, 80, 82, 83, 87, 90, 92, 93, 100, 102, 103, 104, 106, 112, 113, 114, 117, 120, 126, 127, 127:1, 128, 129, 130, 131, 133, 138, 140, 142, 143, 151, 154, 156, 158, 161, 166, 167, 168, 170, 171, 175, 181, 182, 183, 184, 185, 187, 192, 193, 201, 203, 204, 205, 207, 209, 220, 221, 224, 225, 229, 230, 232, 239, 247, 249, 258, 260, 264, 271, 277, 277:1, 278, 279, 280, 284, 288, 290, 296, 298, 300, 317, 324, 326, 333, 335, 338, 342, and 350;

C.I. Acid Black 1, 2, 7, 24, 26, 29, 31, 44, 48, 50, 51, 52, 52:1, 58, 60, 62, 63, 64, 67, 72, 76, 77, 94, 107, 108, 109, 110, 112, 115, 118, 119, 121, 122, 131, 132, 139, 140, 155, 156, 157, 158, 159, 172, 191, 194, and 234;

C.I. Acid Orange 1, 7, 8, 10, 19, 20, 24, 28, 33, 41, 43, 45, 51, 56, 63, 64, 65, 67, 74, 80, 82, 85, 86, 87, 88, 94, 95, 122, 123, and 124;

C.I. Acid Green 3, 7, 9, 12, 16, 19, 20, 25, 27, 28, 35, 36, 40, 41, 43, 44, 48, 56, 57, 60, 61, 65, 73, 75, 76, 78, and 79; and

C.I. Acid Brown 2, 4, 13, 14, 19, 20, 27, 28, 30, 31, 39, 44, 45, 46, 48, 53, 100, 101, 103, 104, 106, 160, 161, 165, 188, 224, 225, 226, 231, 232, 236, 247, 256, 257, 266, 268, 276, 277, 282, 289, 294, 295, 296, 297, 298, 299, 300, 301, and 302.

Examples of the direct dye include C.I. Direct Red 2, 4, 9, 23, 26, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247;

C.I. Direct Violet 7, 9, 47, 48, 51, 66, 90, 93, 94, 95, 98, 100, and 101;

C.I. Direct Yellow 8, 9, 11, 12, 27, 28, 29, 33, 35, 39, 41, 44, 50, 53, 58, 59, 68, 86, 87, 93, 95, 96, 98, 100, 106, 108, 109, 110, 130, 132, 142, 144, 161, and 163;

C.I. Direct Blue 1, 10, 15, 22, 25, 41, 55, 67, 68, 71, 76, 77, 78, 80, 84, 86, 87, 90, 98, 106, 108, 109, 120, 151, 156, 158, 159, 160, 153, 168, 189, 192, 193, 194, 199, 200, 201, 202, 203, 207, 211, 213, 214, 218, 225, 226, 229, 236, 237, 244, 248, 249, 251, 252, 264, 270, 280, 288, 289, and 291; and

C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 195, and 199.

Examples of the reactive dye include C.I. Reactive Yellow 1, 2, 3, 5, 11, 13, 14, 15, 17, 18, 20, 21, 22, 23, 24, 25, 26, 27, 29, 35, 37, 40, 41, 42, 47, 51, 55, 65, 67, 81, 95, 116, 142, and 161;

C.I. Reactive Red 1, 3, 3:1, 4, 13, 14, 17, 19, 21, 22, 23, 24, 24:1, 25, 26, 29, 31, 32, 35, 37, 40, 41, 43, 44, 45, 46, 49, 55, 60, 66, 74, 79, 96, 97, 108, 141, 180, 218, 226, and 245;

C.I. Reactive Violet 1, 3, 4, 5, 6, 7, 8, 9, 16, 17, 22, 23, 24, 26, 27, 33, and 34;

C.I. Reactive Blue 1, 2, 3, 5, 7, 8, 10, 13, 14, 15, 17, 18, 19, 21, 23, 25, 26, 27, 28, 29, 32, 35, 38, 41, 49, 63, 72, 75, 80, 95, and 190;

C.I. Reactive Orange 1, 2, 4, 5, 7, 12, 13, 14, 16, 20, 29, 33, 35, 38, 64, 67, 71, 72, 72:1, 78, 82, 84, 86, 87, 91, 99, 99:1, 107, 113, 122, 124, and 125; and

C.I. Reactive Black 1, 3, 4, 5, 7, 8, 11, 12, 14, 17, 21, 23, 26, 31, 32, 34, and 39.

Examples of the disperse dye include C.I. Disperse Red 60, 82, 86, 86:1, 92, 152, 154, 167:1, 191, and 279;

C.I. Disperse Yellow 64, 71, 86, 114, 153, 163, 233, and 245;

C.I. Disperse Blue 27, 60, 73, 77, 77:1, 87, 165, 165:1, 257, and 367;

C.I. Disperse Violet 26, 33, 36, and 57; and

C.I. Disperse Orange 30, 41, 61, and 80.

In a case where the disperse dye is used, for example, the surface of the disperse dye may be modified by oxidation or sulfonation with ozone, hypochlorous acid, fuming sulfuric acid, or the like for the purpose of enhancing dispersion stability in the ink jet ink composition, in the same manner as in the pigment described below. The dispersibility of the disperse dye may be improved by using a dispersant. The dispersant will be described later.

As the pigment, for example, an inorganic pigment or an organic pigment can be used.

The inorganic pigment is not particularly limited, and examples thereof include carbon black such as C.I. Pigment Black 6 (lamp black and vegetable black), C.I. Pigment Black 7 (furnace black, channel black, thermal black, and acetylene black), C.I. Pigment Black 8 (charcoal black), and C.I. Pigment Black 10 (graphite); and a white pigment such as iron oxide, titanium oxide, zinc oxide, and silica.

Examples of the carbon black include No. 2300, 900, MCF88, No. 20B, No. 33, No. 40, No. 45, No. 52, MA7, MA8, MA100, and No2200B, manufactured by Mitsubishi Chemical Corporation. Examples include color black FW1, FW2, FW2V, FW18, FW200, S150, S160, S170, Pretex 35, U, V, and 140U, and special black 6, 5, 4A, 4, and 250, manufactured by Degussa AG. Examples include Conductex SC and Raven 1255, 5750, 5250, 5000, 3500, 1255, and 700, manufactured by Columbia Carbon Corporation. Examples include REGAL 400R, 330R, and 660R, MOGUL L, MONARCH 700, 800, 880, 900, 1000, 1100, 1300, and 1400, and ELFTEX 12, manufactured by Cabot Corporation.

Examples of the white pigment include C.I. Pigment White 1, which is basic lead carbonate, C.I. Pigment White 4 made from zinc oxide, C.I. Pigment White 5 made from a mixture of zinc sulfide and barium sulfate, C.I. Pigment White 6 made from titanium dioxide, C.I. Pigment White 6:1 formed from titanium dioxide containing another metal oxides, C.I. Pigment White 7 made from zinc sulfide, C.I. Pigment White 18 made from calcium carbonate, C.I. Pigment White 19 made from clay, C.I. Pigment White 20 made from titanium oxide coated mica, C.I. Pigment White 21 made from barium sulfate, C.I. Pigment White 22 made from gypsum, C.I. Pigment White 26 made from magnesium oxide and silicon dioxide, C.I. Pigment White 27 made from silicon dioxide, and C.I. Pigment White 28 made of anhydrous calcium silicate. Among these, C.I. Pigment White 6 which is excellent in color developability, masking properties, and the like is preferably used.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, and an azo-based pigment.

Specific examples of the organic pigment include the following pigments.

Examples of a cyan pigment include C.I. Pigment Blue 1, 2, 3, 15:3, 15:4, 15:34, 16, 22, 60, and the like; C.I. Vat Blue 4, 60; and the like, and are preferably a mixture of one or two or more kinds selected from the group consisting of C.I. Pigment Blue 15:3, 15:4, and 60.

Examples of a magenta pigment include C.I. Pigment Red 5, 7, 12, 48(Ca), 48(Mn), 57(Ca), 57:1, 112, 122, 123, 168, 184, and 202, C.I. Pigment Violet 19, and the like, and are preferably a mixture of one or two or more kinds selected from the group consisting of C.I. Pigment Red 122, 202, and 209, and C.I. Pigment Violet 19.

Examples of a yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and are preferably a mixture of one or two or more kinds selected from the group consisting of C.I. Pigment Yellow 74, 109, 110, 128, 138, 150, and 180.

Pigments of other colors can also be used. Examples thereof include an orange pigment, a green pigment, and the like.

In the case of using the pigment, for example, for the purpose of enhancing dispersion stability in the ink jet ink composition, the surface of the pigment may be modified by oxidation or sulfonation with ozone, hypochlorous acid, fuming sulfuric acid, or the like, and the dispersibility of the pigment may be improved by using a dispersant. Examples of the dispersant include (meth)acrylic resins such as poly(meth)acrylic acid, a (meth)acrylic acid-acrylonitrile copolymer, a (meth)acrylic acid-(meth)acrylic acid ester copolymer, a vinyl acetate-(meth)acrylic acid ester copolymer, a vinyl acetate-(meth)acrylic acid copolymer, and a vinylnaphthalene-(meth)acrylic acid copolymer, and salts thereof; styrene-based resins such as a styrene-(meth)acrylic acid copolymer, a styrene-(meth)acrylic acid-(meth)acrylic acid ester copolymer, a styrene-α-methylstyrene-(meth)acrylic acid copolymer, a styrene-α-methylstyrene-(meth)acrylic acid-(meth)acrylic acid ester copolymer, a styrene-maleic acid copolymer, and a styrene-maleic acid anhydride copolymer, and salts thereof; and polymer compounds containing a urethane bond formed by a reaction between an isocyanate group and a hydroxy group. These may be linear or branched, and examples thereof include water-soluble resins such as urethane-based resins and salts thereof regardless of the presence or absence of a crosslinked structure; polyvinyl alcohols; vinylnaphthalene -maleic acid copolymers and salts thereof; vinyl acetate-maleic acid ester copolymers and salts thereof; and vinyl acetate-crotonic acid copolymers and salts thereof.

Examples of commercially available products of a styrene-acrylic resin dispersant include X-200, X-1, X-205, X-220, and X-228 (manufactured by SEIKO PMC CORPORATION), NOPCOSPERSE (registered trademark) 6100 and 6110 (manufactured by SAN NOPCO LIMITED), JONCRYL 67, 586, 611, 678, 680, 682, ad 819 (manufactured by BASF SE), DISPERBYK 190 (manufactured by BYK Japan KK), and N-EA137, N-EA157, N-EA167, N-EA177, N-EA197D, N-EA207D, and E-EN10 (manufactured by DKS Co. Ltd.).

Examples of commercially available products of an acrylic resin dispersant include BYK-187, BYK-190, BYK-191, BYK 194N, and BYK 199 (manufactured by BYK Japan KK) and Aron A-210, A6114, AS-1100, AS-1800, A-30SL, A-7250, and CL-2 (manufactured by TOAGOSEI CO., LTD.).

Examples of commercially available products of a urethane resin-based dispersant include BYK-182, BYK-183, BYK-184, and BYK-185 (manufactured by BYK Japan KK), TEGO Disperse710 (manufactured by Evonic Tego Chemie GmBH), and Borchi (registered trademark) Gen1350 (manufactured by OMG Borchers GmBH).

The dispersant may be used alone or in combination of two or more kinds thereof. The content of the dispersant is preferably from 5% by mass to 50% by mass, more preferably from 10% by mass to 40% by mass, still more preferably from 15% by mass to 35% by mass, and particularly preferably from 20% by mass to 30% by mass, with respect to 100% by mass of the pigment. When the content of the dispersant is 5% by mass or more with respect to 100% by mass of the pigment, dispersion stability of the pigment tends to be able to be secured. In addition, when the content of the dispersant is 50% by mass or less with respect to 100% by mass of the pigment, there is a tendency that the viscosity of the ink jet ink composition can be suppressed to be small.

The lower limit of the content of the coloring material is not particularly limited, but is preferably 1.0% by mass or more, more preferably 3.0% by mass or more, even more preferably 5.0% by mass or more, still more preferably 7.0% by mass or more, and particularly preferably 10.0% by mass or more, with respect to the total amount of the ink jet ink composition. The upper limit of the content of the coloring material is not particularly limited, but is preferably 30.0% by mass or less, more preferably 25.0% by mass or less, still more preferably 20.0% by mass or less, yet still more preferably 15.0% by mass or less, and particularly preferably 12.0% by mass, with respect to the total amount of the ink jet ink composition.

It is also preferable that the content of the water-soluble dye be in the above-described content ranges. In particular, the content of the water-soluble dye is preferably 5.0% by mass or more and 20.0% by mass or less and more preferably 10.0% by mass or more and 20.0% by mass or less with respect to the total amount of the ink jet ink composition. When the content of the water-soluble dye is in the relatively large ranges described above, precipitation or solidification of the coloring material is likely to occur, and thus clogging recoverability is likely to be deteriorated. However, according to the ink jet ink composition of the present embodiment, there is a tendency that it is possible to obtain favorable clogging recoverability even in such content ranges.

### 1. 2. Organic solvent

The ink jet ink composition according to the present embodiment contains the organic solvent, and the organic solvent contains one or more kinds selected from triethylene glycol monobutyl ether (BTG), tetraethylene glycol monobutyl ether (BTeG), N-hydroxyethyl-2-pyrrolidone, and ε-caprolactam (hereinafter, also referred to as "specific amides"). Although organic solvents generally exhibit liquid properties, even a solid substance (20°C, 1 atm) is handled as an organic solvent in the present specification as long as it has a property of dissolving in another organic solvent to dissolve a substance.

### 1. 2. 1. BTG

The organic solvent contains triethylene glycol monobutyl ether (BTG).

The content of triethylene glycol monobutyl ether (BTG) is not particularly limited, but is preferably 0.5% by mass or more, more preferably 1.0% by mass or more, still more preferably 2.0% by mass or more, particularly preferably 3.0% by mass or more, and more particularly preferably 4.0% by mass or more, with respect to the total amount of the ink jet ink composition. In addition, the content of triethylene glycol monobutyl ether (BTG) is not particularly limited, but is preferably 30.0% by mass or less, more preferably 25.0% by mass or less, still more preferably 20.0% by mass or less, yet still more preferably 15.0% by mass or less, particularly preferably 10.0% by mass or less, and more particularly preferably 8.0% by mass or less, with respect to the total amount of the ink jet ink composition.

In particular, the content of triethylene glycol monobutyl ether (BTG) is preferably 1.0% by mass or more and 20.0% by mass or less with respect to the total amount of the ink jet ink composition. When the content of BTG is within the above ranges, the balance between improvement of the solubility and dispersibility of the coloring material and the viscosity increasing property is more excellent, and the balance between clogging recoverability and continuous ejection stability tends to be more favorably.

In addition, according to the ink jet ink composition according to the present embodiment, even in a case where the content of BTG is relatively large, since it is possible to improve the solubility and dispersibility of the coloring material while reducing an increase in viscosity due to BTG, there is a tendency that it is possible to obtain excellent continuous ejection stability while obtaining excellent clogging recoverability. In a case where the content of BTG is relatively large, for example, the content of BTG is preferably 5.0% by mass or more, more preferably 8.0% by mass or more, still more preferably 10.0% by mass or more, yet still more preferably 12.0% by mass or more, and particularly preferably 15.0% by mass or more, with respect to the total amount of the ink jet ink composition.

### 1. 2. 2. BTeG

The organic solvent contains tetraethylene glycol monobutyl ether (BTeG).

The content of tetraethylene glycol monobutyl ether (BTeG) is not particularly limited, but is preferably 0.01% by mass or more, more preferably 0.05% by mass or more, still more preferably 0.10% by mass or more, particularly preferably 0.20% by mass or more, and more particularly preferably 0.40% by mass or more, with respect to the total amount of the ink jet ink composition. In addition, the content of tetraethylene glycol monobutyl ether (BTeG) is not particularly limited, but is preferably 15.0% by mass or less, more preferably 10.0% by mass or less, still more preferably 5.0% by mass or less, yet still more preferably 3.0% by mass or less, particularly preferably 1.5% by mass or less, and more particularly preferably 1.0% by mass or less, with respect to the total amount of the ink jet ink composition.

Even when the content of BTeG is in the relatively small ranges described above, there is a tendency that the solubility and dispersibility of the coloring material are improved while reducing an increase in viscosity due to BTG, and excellent clogging recoverability and continuous ejection stability can be obtained.

The mass ratio (BTeG/BTG) of the content of tetraethylene glycol monobutyl ether to the content of triethylene glycol monobutyl ether is preferably 3% or more, more preferably 5% or more, still more preferably 7% or more, and particularly preferably 9% or more. The mass ratio (BTeG/BTG) is also preferably 50% or less, more preferably 20% or less, still more preferably 15% or less, and particularly preferably 13% or less.

In particular, the mass ratio (BTeG/BTG) of the content of tetraethylene glycol monobutyl ether to the content of triethylene glycol monobutyl ether is preferably 5% or more and 15% or less. When the mass ratio (BTeG/BTG) is within the above ranges, there is a tendency that the solubility and dispersibility of the coloring material are further improved while further reducing an increase in viscosity due to BTG, and more excellent clogging recoverability and continuous ejection stability can be obtained.

### 1. 2. 3. Specific amides

The organic solvent contains one or more kinds selected from N-hydroxyethyl -2-pyrrolidone (HEP) and ε-caprolactam (εCPL) (specific amides).

The content of one or more kinds selected from N-hydroxyethyl-2-pyrrolidone and ε-caprolactam is not particularly limited, but is preferably 1.0% by mass or more, more preferably 3.0% by mass or more, and still more preferably 5.0% by mass or more, with respect to the total amount of the ink jet ink composition. The content of one or more kinds selected from N-hydroxyethyl-2-pyrrolidone and ε-caprolactam is not particularly limited, but is preferably 20.0% by mass or less, more preferably 15.0% by mass or less, still more preferably 12.0% by mass or less, yet still more preferably 10.0% by mass or less, and particularly preferably 8.0% by mass or less, with respect to the total amount of the ink jet ink composition.

In particular, the content of one or more kinds selected from N-hydroxyethyl-2-pyrrolidone and ε-caprolactam is preferably 5.0% by mass or more and 15.0% by mass or less with respect to the total amount of the ink jet ink composition. When the specific nitrogen-containing solvent is in the above-described ranges, the balance between hydrophilicity and hydrophobicity in the ink components becomes more favorable, and continuous ejection stability tends to be further improved.

The mass ratio ((BTG + BTeG)/(HEP + εCPL)) of the total content (BTG + BTeG) of triethylene glycol monobutyl ether and tetraethylene glycol monobutyl ether to the content (HEP + εCPL) of one or more kinds selected from N-hydroxyethyl-2-pyrrolidone and ε-caprolactam is preferably 10% or more, more preferably 20% or more, still more preferably 30% or more, and particularly preferably 50% or more. The mass ratio ((BTG + BTeG)/(HEP + εCPL)) is also preferably 300% or less, more preferably 250% or less, still more preferably 200% or less, particularly preferably 150% or less, and more particularly preferably 100% or less. When the mass ratio is within the above ranges, clogging recoverability and continuous ejection stability tend to be excellent.

### 1. 2. 4. Other organic solvents

The organic solvent may contain an organic solvent other than those described above. Examples of other organic solvents include esters, glycol ethers, cyclic esters, amides, alcohols, and polyhydric alcohols.

Esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters such as ethylene glycol diacetate, diethylene glycol diacetate, propylene glycol diacetate, dipropylene glycol diacetate, propionate ethylene glycol acetate, butyrate ethylene glycol acetate, butyrate diethylene glycol acetate, propionate diethylene glycol acetate, butyrate diethylene glycol acetate, propionate propylene glycol acetate, butyrate propylene glycol acetate, butyrate dipropylene glycol acetate, and propionate dipropylene glycol acetate.

Examples of the glycol ethers include monoethers and diethers of alkylene glycols.

Examples of the monoethers of alkylene glycols include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, tetraethylene glycol monomethyl ether, tetraethylene glycol monoethyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether.

Examples of the diethers of alkylene glycols include alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; and compounds in which a hydrogen atom of a methylene group adjacent to the carbonyl group of these cyclic esters is substituted with an alkyl group having 1 to 4 carbon atoms.

Examples of the amides include cyclic amides (lactams) such as 2-pyrrolidone, 2-piperidone, N-methyl-ε-caprolactam, N-cyclohexyl-2-pyrrolidone, N-methylpyrrolidone, N-ethylpyrrolidone, N-butylpyrrolidone, 5-methyl-2-pyrrolidone, β-propiolactam, and ω-heptalactam; and chain amides such as N,N-dimethylacetoacetamide, N,N-diethylacetoacetamide, N-methylacetoacetamide, N,N-dimethylisobutyramide, N,N-dimethylformamide, N,N-diethylformamide, N,N-dimethylacetamide, N,N-diethylacetamide, N,N-dimethylpropionamide, 3-methoxy-N,N-dimethylpropanamide (DMPA), 3-n-butoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Examples of the alcohols include a compound in which one hydrogen atom of an alkane is substituted with a hydroxy group. The alkane preferably has 10 or less carbon atoms, more preferably 6 or less carbon atoms, and still more preferably 3 or less carbon atoms. The number of carbon atoms of the alkane is 1 or more, and is preferably 2 or more. The alkane may be a linear type or a branched type. Examples of the alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, and phenoxy propanol.

Polyhydric alcohols have two or more hydroxy groups in the molecule. The polyhydric alcohols can be divided into, for example, alkanediols and polyols.

Examples of the alkanediols include compounds in which an alkane is substituted with two hydroxy groups. Examples of the alkanediols include 1,2-alkanediol, which is a general term for compounds in which an alkane is substituted with hydroxy groups at the first and second positions, and other alkanediols other than 1,2-alkanediol. The alkanediols are preferably diols of alkanes having 5 or more carbon atoms. The number of carbon atoms of the alkane is preferably 5 to 15, more preferably 6 to 10, and still more preferably 6 to 8. 1,2-Alkanediols are preferable.

Examples of the 1,2-alkanediol include ethylene glycol, 1,2-propanediol (propylene glycol), 1,2-butanediol, 1,2-pentanediol (1,2PD), 1,2-hexanediol, 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, and 2-methyl-2-propyl-1,3-propanediol.

Examples of the polyols include a condensate in which two or more molecules of alkanediols are intermolecularly condensed between hydroxy groups, and a compound having three or more hydroxy groups.

The polyol is preferably a polyol of an alkane having 4 or less carbon atoms or an intermolecular condensate of hydroxy groups of a polyol of an alkane having 4 or less carbon atoms. The number of carbon atoms of the alkane is preferably 2 or 3. The number of hydroxy groups in the molecule of the polyols is 2 or more, preferably 5 or less, and more preferably 3 or less. When the polyol is the intermolecular condensate described above, the number of intermolecular condensates is 2 or more, preferably 4 or less, and more preferably 3 or less.

Examples of the condensate in which two or more molecules of alkanediols are intermolecularly condensed between hydroxy groups include dialkylene glycols such as diethylene glycol and dipropylene glycol, and trialkylene glycols such as triethylene glycol and tripropylene glycol.

The compound having three or more hydroxy groups is a compound having an alkane or polyether structure as a skeleton and having three or more hydroxy groups. Examples of the compound having three or more hydroxy groups include glycerin, trimethylolethane, trimethylolpropane, 1,2,5-hexanetriol, 1,2,6-hexanetriol, pentaerythritol, and polyoxypropylene triol.

The other organic solvents may be used alone or in combination of two or more kinds thereof.

Among these other organic solvents, a polyhydric alcohol is preferably contained, one or more kinds selected from an alkanediol and a polyol are more preferably contained, and an alkanediol is still more preferably contained.

The content of the other organic solvent is not particularly limited, but is preferably 1.0% by mass or more, more preferably 3.0% by mass or more, and still more preferably 5.0% by mass or more with respect to the total amount of the ink jet ink composition. In addition, the content of the other organic solvent is not particularly limited, but is preferably 20.0% by mass or less, more preferably 15.0% by mass or less, and still more preferably 12.0% by mass or less with respect to the total amount of the ink jet ink composition.

The total content of the organic solvent is not particularly limited, but is preferably 5.0% by mass or more, more preferably 10.0% by mass or more, and still more preferably 15.0% by mass or more with respect to the total amount of the ink jet ink composition. In addition, the total content of the organic solvent is not particularly limited, but is preferably 50.0% by mass or less, more preferably 40.0% by mass or less, and still more preferably 30.0% by mass or less with respect to the total amount of the ink jet ink composition.

### 1. 3. Water

The ink jet ink composition according to the present embodiment contains water.

Examples of water include pure water such as ion-exchanged water, ultrafiltration water, reverse osmosis water, and distilled water, and water having reduced ionic impurities such as ultrapure water. In addition, when water sterilized by ultraviolet irradiation, addition of hydrogen peroxide, or the like is used, it is possible to suppress generation of bacteria or fungi in a case where a maintenance liquid is stored for a long period of time.

The content of water in the liquid medium component is preferably 50% by mass or more, and more preferably 50% to 99% by mass. Furthermore, the content is preferably 60% to 90% by mass, more preferably 65% to 85% by mass, and still more preferably 65% to 80% by mass. Note that, the liquid medium is a solvent component such as water or an organic solvent.

In addition, the content of water is preferably 30% by mass or more, more preferably 50% by mass or more, and still more preferably 70% by mass or more with respect to the total amount of the ink jet ink composition. The upper limit of the content of water is not particularly limited, but is, for example, preferably 99% by mass or less, more preferably 90% by mass or less, and still more preferably 80% by mass or less with respect to the total amount of the ink jet ink composition.

### 1. 4. Fixing resin

The ink jet ink composition according to the present embodiment may contain a fixing resin. The fixing resin has, for example, a function to improve adhesiveness and abrasion resistance of the ink component, and a function to smooth the surface of a recording medium or the surface of an ink coating film.

The fixing resin may be a water-soluble resin in terms of properties and is preferably resin particles. The resin particles are often handled in a form of an emulsion, but may also have properties as powder. The fixing resin can be dispersed or dissolved in the solvent component of the ink and contained.

Examples of the fixing resin include a urethane-based resin; an acrylic resin (including a styrene-acrylic resin); a fluorene-based resin; a polyolefin-based resin; a rosin-modified resin; a terpene-based resin; a polyester-based resin; a polyamide-based resin; an epoxy-based resin; a vinyl chloride-based resin; a vinyl chloride-vinyl acetate copolymer, and an ethylene-vinyl acetate-based resin. Among these, a urethane-based resin, an acrylic resin, a polyolefin-based resin, and a polyester-based resin are preferable.

The urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like may be used. In addition, commercially available products may be used as the urethane resin, and for example, commercially available products such as SUPERFLEX 460, 460s, 840, and E-4000 (product names, manufactured by DKS Co. Ltd.), REZAMINE D-1060, D-2020, D-4080, D-4200, D-6300, and D-6455 (product names, manufactured by Dainichiseika Color & Chemicals Mfg. Co., Ltd.), TAKELAC WS-6021, WS-5100, and W-512-A-6 (product names, manufactured by Mitsui Chemicals, Inc.), Sancure 2710 (product name, manufactured by The Lubrizol Corporation), and PERMARIN UA-150 (product name, manufactured by Sanyo Chemical Industries, Ltd.) may be used.

The acrylic resin is a general term for a polymer obtained by polymerizing at least an acrylic monomer such as (meth)acrylic acid and (meth)acrylic acid ester as one component, and examples thereof include a resin obtained from an acrylic monomer, and a copolymer of an acrylic monomer and a monomer other than acrylic monomers. Examples thereof include an acrylic-vinyl-based resin which is a copolymer of an acrylic monomer and a vinyl-based monomer. In addition, examples of the vinyl-based monomer include styrene.

As the acrylic monomer, acrylamide, acrylonitrile, and the like can also be used. A commercially available product may be used as the resin emulsion using an acrylic resin as a raw material, and the resin emulsion used may be selected from FK-854, Mowinyl 6969D, 6899D, 952B, and 718A (product names, manufactured by Japan Coating Resin Corporation), and NipolLX852 and LX874 (product names, manufactured by Zeon Corporation), for example.

Incidentally, in the present specification, the acrylic resin may be a styrene-acrylic resin described later.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, and a styrene-α-methylstyrene-acrylic acid-acrylic acid ester copolymer. As the styrene acrylic resin, a commercially available product may be used, and for example, JONCRYL 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (product names, manufactured by BASF SE), Mowinyl 966A and 975N (product names, manufactured by Japan Coating Resin Corporation), VINYBLAN 2586 (manufactured by Nissin Chemical Industry Co., Ltd.), and the like may be used.

The polyolefin-based resin has an olefin such as ethylene, propylene, or butylene in the structural skeleton, and known resins can be appropriately selected and used. As the olefin resin, a commercially available product can be used, and for example, ARROWBASE CB-1200 and CD-1200 (product names, manufactured by UNITIKA LTD.), and the like may be used.

Further, the fixing resin may be supplied in a form of an emulsion, and examples of commercially available products of such a resin emulsion used may be selected from MICROGEL E-1002 and E-5002 (product names, manufactured by Nippon Paint Co., Ltd., styrene-acrylic resin emulsion), VONCOAT 4001 (product name, manufactured by DIC Corporation, acrylic resin emulsion), VONCOAT 5454 (product name, manufactured by DIC Corporation, styrene-acrylic resin emulsion), POLYSOL AM-710, AM-920, AM-2300, AP-4735, AT-860, and PSASE-4210E (acrylic resin emulsion), POLYSOL AP-7020 (styrene-acrylic resin emulsion), POLYSOL SH-502 (vinyl acetate resin emulsion), POLYSOL AD-13, AD-2, AD-10, AD-96, AD-17, AD-70 (ethylene-vinyl acetate resin emulsion), POLYSOL PSASE-6010 (ethylene-vinyl acetate resin emulsion) (product name, manufactured by Showa Denko K.K.), POLYSOL SAE1014 (product name, manufactured by Zeon Corporation, styrene-acrylic resin emulsion), Saibinol SK-200 (product name, manufactured by SAIDEN CHEMICAL INDUSTRY CO., LTD., acrylic resin emulsion), AE-120A (product name, manufactured by JSR Corporation, acrylic resin emulsion), AE373D (product name, manufactured by Etec Corporation, carboxy-modified styrene-acrylic resin emulsion), SEIKADYNE 1900W (product name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate acrylic resin emulsion), VINYBLAN 5202 (acetic acid acrylic resin emulsion) (product name, manufactured by Nissin Chemical Industry Co., Ltd.), ELITEL KA-5071S, KT-8803, KT-9204, KT-8701, KT-8904, and KT-0507 (product names, manufactured by UNITIKA LTD., polyester resin emulsion), Hytec SN-2002 (product name, manufactured by TOHO Chemical Industry Co., Ltd.), polyester resin emulsion), TAKELAC W-6020, W-635, W-6061, W-605, W-635, and W-6021 (product name, manufactured by Mitsui Chemicals, Inc., urethane-based resin emulsion), SUPERFLEX 870, 800, 150, 420, 460, 470, 610, and 700 (product name, manufactured by DKS Co. Ltd., urethane-based resin emulsion), PERMARIN UA-150 (manufactured by Sanyo Chemical Industries, Ltd., urethane-based resin emulsion), Sancure 2710 (manufactured by The Lubrizol Corporation, Japan, urethane-based resin emulsion), NeoRez R-9660, R-9637, and R-940 (manufactured by Kusumoto Chemicals, Ltd., urethane-based resin emulsion), ADEKA BONTIGHTER HUX-380 and 290K (manufactured by ADEKA CORPORATION, urethane-based resin emulsion), Mowinyl 966A and Mowinyl 7320 (manufactured by Japan Coating Resin Corporation), JONCRYL 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (which are all manufactured by BASF SE), NK Binder R-5HN (manufactured by SHIN-NAKAMURA CHEMICAL Co., Ltd.), HYDRAN WLS-210 (non-crosslinkable polyurethane: manufactured by DIC Corporation), JONCRYL 7610 (manufactured by BASF SE) or the like.

The content of the fixing resin is preferably 0.5% by mass or more, more preferably 1.0% by mass or more, even more preferably 2.0% by mass or more, and particularly preferably 3.0% by mass or more with respect to the total amount of the ink jet ink composition, from a viewpoint of a tendency to be more excellent in abrasion resistance.

In addition, the content of the fixing resin is preferably 15.0% by mass or less, more preferably 10% by mass or less, still more preferably 8.0% by mass or less, and yet still more preferably 5.0% by mass or less with respect to the total amount of the ink jet ink composition, from the viewpoint of a tendency to be more excellent in ejection stability.

### 1. 5. Surfactant

The ink jet ink composition according to the present embodiment may contain a surfactant. As the surfactant, any of nonionic surfactants, anionic surfactants, cationic surfactants, and amphoteric surfactants can be used, and these surfactants may be used in combination. In addition, among the surfactants, an acetylene glycol-based surfactant, a silicone-based surfactant, and a fluorine-based surfactant can be more preferably used, and an acetylene glycol-based surfactant can be still more preferably used.

The acetylene glycol-based surfactant is not particularly limited, and for example, one or more kinds selected from alkyleneoxide adducts of 2,4,7,9-tetramethyl-5-decyne-4,7-diol and 2,4,7,9-tetramethyl-5-decyne-4,7-diol, and alkyleneoxide adducts of 2,4-dimethyl-5-decyne-4-ol and 2,4-dimethyl-5-decyne-4-ol are preferable. Commercially available products of the acetylene glycol-based surfactant are not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (which are all product names, manufactured by Air Products Japan, Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (which are all product names, manufactured by Nissin Chemical Industry Co., Ltd.), and Acetylenol E00, E00P, E40, and E100 (which are all product names, manufactured by Kawaken Fine Chemicals Co., Ltd.). The acetylene glycol-based surfactant may be used alone or in combination of two or more kinds thereof.

The silicone-based surfactant is not particularly limited, and examples thereof include a polysiloxane-based compound and a polyether-modified organosiloxane. Examples of commercially available silicone-based surfactants include, but are not particularly limited to, BYK-306, BYK-307, BYK-333, BYK-341, BYK-345, BYK-346, BYK-348, and BYK 349 (which are product names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF 6017 (which are product names, manufactured by Shin-Etsu Chemical Co., Ltd.), and SILFACE SAG503A and SILFACE SAG014 (which are product names, manufactured by Nissin Chemical Industry Co., Ltd.). The silicone-based surfactant may be used alone or in combination of two or more kinds thereof.

The fluorine-based surfactant is not particularly limited, and examples thereof include a perfluoroalkyl sulfonate, a perfluoroalkyl carboxylate, a perfluoroalkyl phosphonate, a perfluoroalkyl ethylene oxide adduct, a perfluoroalkyl betaine, and a perfluoroalkyl amine oxide compound. Examples of commercially available fluorine-based surfactants include, but are not particularly limited to, S-144 and S-145 (which are product names, manufactured by AGC Inc.), FC-170C, FC-430, and Fluorad FC4430 (which are product names, manufactured by Sumitomo 3M Limited), FSO, FSO-100, FSN, FSN-100, and FS-300 (which are product names, manufactured by DuPont de Nemours, Inc.), and FT-250 and 251 (which are product names, manufactured by NEOS COMPANY LIMITED). The fluorine-based surfactant may be used alone or in combination of two or more kinds thereof.

The surfactant may be used alone or in combination of two or more kinds thereof. Note that among the exemplified surfactants, a surfactant which functions as a defoaming agent may also be used. Examples of such a defoaming agent include SURFYNOL DF110D (product name, manufactured by Air Products Japan, Inc.).

The content of the surfactant is preferably 5.0% by mass or less, more preferably 3.0% by mass or less, still more preferably 2.0% by mass or less, particularly preferably 1.0% by mass or less, and yet particularly preferably 0.5% by mass or less with respect to the total amount of the ink jet ink composition. In addition, the lower limit of the content of the surfactant is not particularly limited, but is preferably 0.01% by mass or more, more preferably 0.05% by mass or more, still more preferably 0.10% by mass or more, and yet still more preferably 0.15% by mass or more with respect to the total amount of the ink jet ink composition.

### 1. 6. pH adjuster

The ink jet ink composition according to the present embodiment may contain a pH adjuster.

The pH adjuster is not particularly limited, and examples thereof include an appropriate combination of an acid, a base, a weak acid, and a weak base.

As examples of the acid and the base used in such a combination, inorganic acids such as sulfuric acid, hydrochloric acid, and nitric acid; inorganic bases such as lithium hydroxide, sodium hydroxide, potassium hydroxide, dihydrogen potassium phosphate, hydrogen disodium phosphate, potassium carbonate, sodium carbonate, hydrogen sodium carbonate, and ammonia; organic bases such as triethanol amine, diethanol amine, monoethanol amine, tripropanol amine, triisopropanol amine, diisopropanol amine, and tris(hydroxymethyl)aminomethane (THAM); and organic acids such as Good's buffers such as adipic acid, citric acid, succinic acid, lactic acid, N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer solution, a citrate buffer solution, a Tris buffer solution, and the like may be used. Among these, inorganic bases are preferable, and potassium hydroxide is more preferable.

The pH adjuster may be used alone or in combination of two or more kinds thereof.

The total content of the pH adjuster is preferably 5.00% by mass or less, more preferably 3.00% by mass or less, still more preferably 1.00% by mass or less, particularly preferably 0.70% by mass or less, and yet particularly preferably 0.50% by mass or less with respect to the total amount of the ink jet ink composition. In addition, the lower limit of the total content of the pH adjuster is not particularly limited, but is preferably 0.01% by mass or more, more preferably 0.05% by mass or more, still more preferably 0.10% by mass or more, and yet still more preferably 0.15% by mass or more with respect to the total amount of the ink jet ink composition.

### 1. 7. Other Components

The ink jet ink composition according to the present embodiment may further contain various additives such as urea, a chelating agent, an antiseptic agent/antifungal agent, an amine, a sugar, a rust inhibitor, a viscosity modifier, an antioxidant, and a fungicide, if necessary.

Examples of the urea include urea, ethylene urea, tetramethylurea, thiourea, and 1,3-dimethyl-2-imidazolidinone, and betaines (trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, acetylcarnitine, and the like).

In a case where the urea is contained, the content thereof is not particularly limited, but is preferably 0.5% to 10% by mass, more preferably 1% to 8% by mass, still more preferably 1% to 5% by mass, and particularly preferably 2% to 4% by mass with respect to the total amount of the ink jet ink composition.

Examples of the chelating agent include ethylenediaminetetraacetic acid (EDTA) and salts thereof (e.g., disodium dihydrogen ethylenediaminetetraacetate), 3-hydroxy-2,-2'-iminodisuccinic acid (HIDS) and salts thereof (tetrasodium 3-hydroxy-2,-2'-iminodisuccinate), and iminodisuccinic acid (IDS) and salts thereof (tetrasodium iminodisuccinate).

In a case where the chelating agent is contained, the content thereof is not particularly limited, but is preferably 0.001% to 1.000% by mass, more preferably 0.005% to 0.100% by mass, still more preferably 0.010% to 0.050% by mass, and particularly preferably 0.010% to 0.030% by mass with respect to the total amount of the ink jet ink composition.

Examples of the antiseptic agent/antifungal agent include sodium benzoatem, sodium pentachlorophenol, sodium 2-pyridinethiol-1-oxide, sodium sorbate, sodium dehydroacetate, 1,2-benzisothiazolin-3-one, and octyldiethanolamine. As the antiseptic agent/antifungal agent, a commercially available product may be used, and examples of the commercially available product include PROXEL XL-2 and PROXEL GXL (which are product names, manufactured by Avecia, 1,2-dibenzoisothiazolin-3-one), and DENICIDE CSA and NS-500W (which are product names, manufactured by Nagase ChemteX Corporation).

In a case where the antiseptic agent/antifungal agent is contained, the content thereof is not particularly limited, but is preferably 0.01% to 5.00% by mass, more preferably 0.05% to 3.00% by mass, still more preferably 0.10% to 1.00% by mass, and particularly preferably 0.10% to 0.50% by mass with respect to the total amount of the ink jet ink composition.

### 1. 8. Production and physical properties of ink jet ink composition

The ink jet ink composition according to the present embodiment can be obtained by mixing the above-described components in an arbitrary order and removing impurities by performing filtration or the like as necessary. As a mixing method, a method of sequentially adding materials to a container provided with a stirring device such as a mechanical stirrer or a magnetic stirrer and stirring and mixing the materials is suitably used. As a filtration method, for example, centrifugal filtration, filter filtration, or the like can be performed as necessary.

In the ink jet ink composition according to the present embodiment, the surface tension at 20°C is preferably 20 mN/m or more and 40 mN/m or less and more preferably 22 mN/m or more and 35 mN/m or less from the viewpoint of reliability as an ink jet ink. From the same viewpoint, the ink viscosity at 20°C is preferably 1.5 mPa·s or more and 10 mPa·s or less, and more preferably 2 mPa·s or more and 8 mPa·s or less. One method for adjusting the surface tension and the viscosity within the above-described ranges is to adjust the types of the above-described organic solvent and surfactant, and the amounts of the organic solvent, the surfactant, and water to be added.

### 2. Ink jet recording method

The ink jet recording method according to one embodiment of the present disclosure includes ejecting the ink jet ink composition described above from an ink jet head and attaching the ink jet ink composition to a recording medium.

According to the ink jet recording method of the present embodiment, by using the above-described ink jet ink composition, it is possible to obtain excellent clogging recoverability and excellent continuous ejection stability.

### 2. 1. Ink attaching step

The ink jet recording method according to the present embodiment includes ejecting the ink jet ink composition described above from an ink jet head and attaching the ink jet ink composition to a recording medium (ink attaching step).

The ink attaching step can be performed by using an ink jet recording apparatus described below. That is, attaching of the ink jet ink composition to a recording medium can be performed by filling the ink jet head with the ink jet ink composition describe above so that the ink jet ink composition can be ejected from a predetermined nozzle and ejecting the ink jet ink composition to the recording medium at a predetermined timing in this state.

The recording medium is not particularly limited, and may have a recording surface that absorbs a liquid or may not have a recording surface that absorbs a liquid. Therefore, the recording medium is not particularly limited, and for example, paper, a film, fabric, metal, glass, a polymer, or the like can be used. In addition, transfer paper for performing sublimation transfer onto a recording medium can also be used as the recording medium of the ink jet recording method.

The fabric is not particularly limited. A material constituting the fabric is not particularly limited, examples thereof include natural fibers such as cotton, linen, wool, and silk, synthetic fibers such as polypropylene, polyester, acetate, triacetate, polyamide, and polyurethane, and biodegradable fibers such as polylactic acid, and blended fibers thereof may be used. As the fabric, the fibers described above may be in any form such as woven fabric, knitted fabric, and nonwoven fabric, and may be fabric of mixed fibers or the like.

### 2. 2. Pretreatment liquid attaching step

The ink jet recording method according to the present embodiment may include attaching a pretreatment liquid to the recording medium before the ink attaching step. Consequently, the color developability and the like of the ink may sometimes be further improved.

As the method of attaching the pretreatment liquid to a recording medium, any one of non-contact type and contact type methods such as an ink jet method, an application method using a roller, a bar, and the like, a method of applying the pretreatment liquid to the recording medium using various sprays, a method of applying the pretreatment liquid by immersing the recording medium in the pretreatment liquid, and a method of applying the pretreatment liquid to the recording medium using a brush and the like, or a combined method thereof can be used.

A component contained in the pretreatment liquid is not particularly limited, and examples thereof include an ammonium salt, a thickener, water, and urea. Hereinafter, components contained in the pretreatment liquid will be described.

The pretreatment liquid may contain an ammonium salt. The ammonium salt is not particularly limited, but is preferably one or more selected from the group consisting of ammonium formate, ammonium acetate, ammonium chloride, and ammonium nitrate, for example.

The content of the ammonium salt is preferably 0.1% by mass to 10% by mass, more preferably 1% by mass to 8% by mass, and still more preferably 3% by mass to 6% by mass with respect to the total amount of the pretreatment liquid.

The pretreatment liquid may contain a thickener. The thickener has a function to, for example, increase the initial viscosity or further improve the rate of change in viscosity due to drying.

The thickener is not particularly limited, and examples thereof include natural gums such as guar gum and locust bean gum, starches, seaweeds such as sodium alginate and Funori, plant skins such as pectic acid, cellulose derivatives such as methyl cellulose, ethyl cellulose, hydroxyethyl cellulose, carboxymethyl cellulose, modified starch such as roasted starch, alpha starch, carboxymethyl starch, carboxyethyl starch, hydroxyethyl starch, processed natural gums such as a shiraz gum-based gum and a locust bean gum, an algin derivative, or synthetic glue such as polyvinylpyrrolidone, polyethylene oxide, polyvinyl alcohol, and polyacrylate, and an emulsion. The thickener may be used alone or in combination of two or more kinds thereof.

The content of the thickener is preferably 0.1% to 5% by mass, more preferably 0.5% to 4% by mass, and still more preferably 1% to 3% by mass with respect to the total amount of the pretreatment liquid.

The pretreatment liquid may contain water. The content, type, and the like of water are the same as those of the ink jet ink composition described above.

The pretreatment liquid may contain urea. The type and the like of urea are the same as those of the ink jet ink composition described above. The content of urea is preferably 1% to 30% by mass, more preferably 3% to 20% by mass, and still more preferably 5% to 15% by mass with respect to the total amount of the pretreatment liquid.

The pretreatment liquid may contain, as a component other than the above-described components, the components which may be contained in the above-described ink jet ink composition, such as the organic solvent, surfactant, pH adjuster, and various additives described above.

### 2. 3. Drying step

The ink jet recording method according to the present embodiment may include drying the recording medium (drying step). For example, when an ink jet recording apparatus is used, the drying of the recording medium can be performed using a drying unit or the like described below. In addition, the drying step may be performed by an appropriate drying unit without being limited to the ink jet recording apparatus. Thus, there is a tendency that an obtained image can be dried, bleeding of the image can be suppressed, and the image can be more efficiently fixed.

### 2. 4. Other steps

The ink jet recording method according to the present embodiment may further include other steps as appropriate, and may include applying another composition, a cleaning step, and the like, for example.

### 2. 5. Ink jet recording apparatus

In the ink jet recording method according to the present embodiment, the ink jet recording apparatus used may be either a serial type or a line type. In these types of ink jet recording apparatuses, an ink jet head is mounted, and it is possible to form a predetermined image by discharging liquid droplets of the ink jet ink composition from a nozzle hole of the ink jet head at a predetermined timing and in a predetermined volume (mass) and attaching the ink jet ink composition to the recording medium while changing the relative positional relationship between the recording medium and the ink jet head.

In the ink jet recording apparatus, for example, a known configuration such as a drying unit, a roll unit, and a winding device can be arbitrarily adopted. In addition, the ink jet recording apparatus may include a transporting unit which transports the recording medium, an image layer forming unit which records an image using the ink jet ink composition, a drying unit which performs heating or blowing of a recording surface, and the like.

The transporting unit can be constituted by, for example, a roller. In this case, a plurality of rollers may be provided. As another unit, a method in which the recording medium is brought into close contact with and adsorbed to a rubber belt or the like to be transported may be used. The transporting unit may be provided at any position and in any number as long as the recording medium can be transported. The transporting unit may include a roll mechanism, a tray, various platens, and the like.

The image layer forming unit records an image layer by discharging the ink jet ink composition described above onto the recording surface of the recording medium. The image layer forming unit includes an ink jet head provided with a nozzle, and a nozzle row is assigned to each predetermined composition.

The drying unit can be used for heating and drying the image layer formed on the recording surface and/or removing a volatile component on the recording medium. The drying unit may be provided at any position and any number of drying units may be provided in consideration of the timing of performing the attaching step, the transport path of the recording medium, and the like. Examples of the drying unit include a method of applying heat to the recording medium by, for example, heating a platen, a method of blowing air onto the image on the recording medium, a method of combining these methods, and the like. Specifically, forced air heating, radiation heating, conductive heating, high-frequency drying, microwave drying, or the like may be used in these methods.

### 3. Examples

The present disclosure will be described in more detail with reference to examples, but the present disclosure is not limited to these examples below. Hereinafter, "%" is based on mass unless otherwise specified.

### 3. 1. Preparation of ink jet ink composition

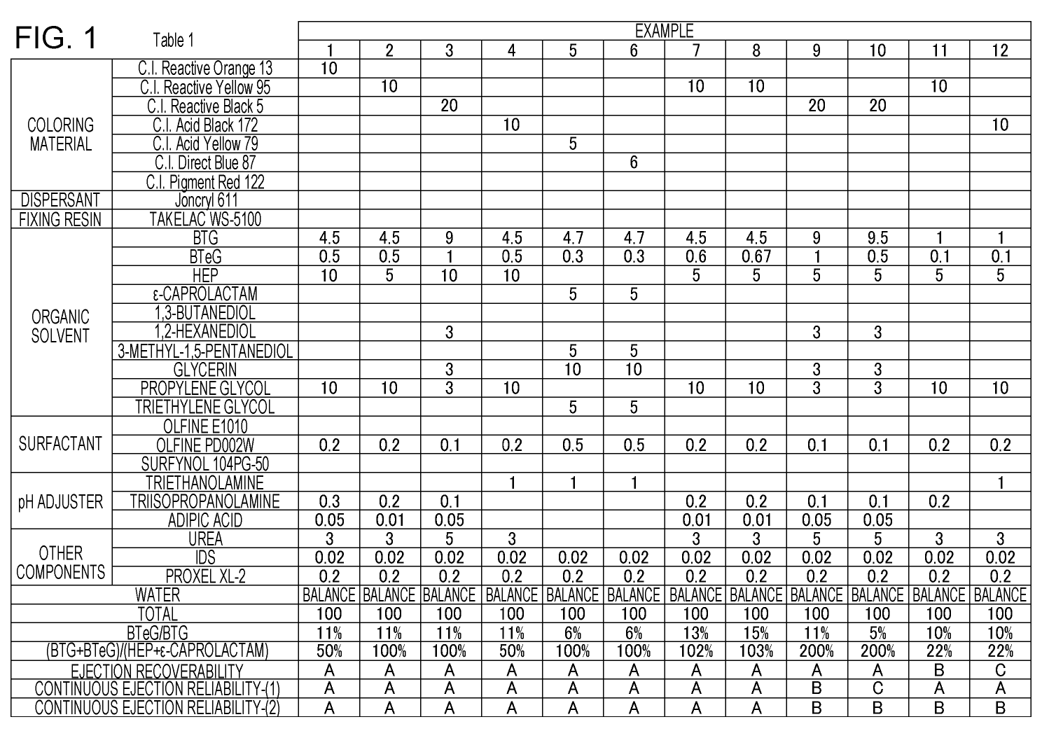

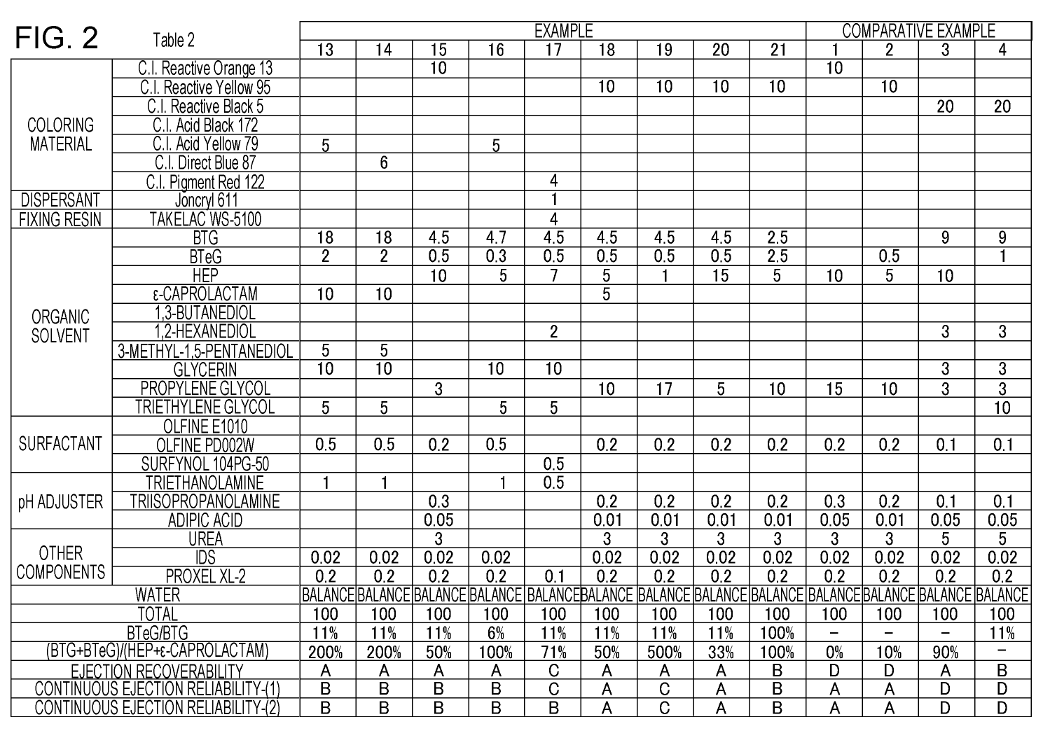

The ink jet ink compositions according to Examples 1 to 16 and 18 to 21 and Comparative Examples 1 to 4 were obtained by putting the respective components into a container so as to have the compositions of Table 1 (FIG. 1) and Table 2 (FIG. 2), mixing and stirring the components with a magnetic stirrer for 2 hours, and then filtering the components with a membrane filter having a pore diameter of 5 μm. Water was added so that the total amount of the composition became 100% by mass.

The ink jet ink composition according to Example 17 was obtained by first mixing 40 g of Pigment Red 122, 10 g of JONCRYL 611, 5 g of triethanolamine, and 200 g of water, and dispersing the mixture for 10 hours with a ball mill using zirconia beads. The resulting stock dispersion was filtered through a membrane filter having a pore size of about 8 μm to remove coarse particles, and diluted with water to achieve a pigment concentration of 10% by mass, thereby preparing a pigment dispersion.

Next, the components listed in Table 2, except for Pigment Red 122, JONCRYL 611, triethanolamine, and water, were put into a container, 15% by mass of water was further added, followed by stirring and mixing. The ink jet ink composition according to Example 17 was obtained by adding 40% by mass of the pigment dispersion and water so that the total amount became 100% by mass, stirring the mixture for 2 hours, and filtering the mixture with a membrane filter having a pore diameter of about 5 μm.

The descriptions in Tables 1 and 2 will be supplemented.

### Dispersant

JONCRYL 611: styrene-acrylic acid copolymer (manufactured by BASF SE)

### Fixing resin

TAKELAC WS-5100: urethane-based resin emulsion (manufactured by Mitsui Chemicals, Inc., the numerical value in the tables represents the solid content)

### Organic solvent

BTG: triethylene glycol monobutyl ether

BTeG: tetraethylene glycol monobutyl ether

HEP: N-hydroxyethyl-2-pyrrolidone

### Surfactant

OLFINE E1010: acetylene glycol-based surfactant (manufactured by Nissin Chemical Industry Co., Ltd.)

OLFINE P002W: acetylene glycol-based surfactant (manufactured by Nissin Chemical Industry Co., Ltd.)

SURFYNOL 104PG-50: acetylene glycol-based surfactant (manufactured by Nissin Chemical Industry Co., Ltd.)

### Other components

IDS: iminodisuccinic acid

PROXEL XL-2: 1,2-dibenzoisothiazolin-3-one-based antiseptic agent (manufactured by Lonza Japan K.K.)

### 3. 2. Evaluation test

### 3. 2. 1. Ejection recoverability

A Cyan column of ink jet printer EW M770T (manufactured by Seiko Epson Corporation) was filled with the prepared ink jet ink composition of each example. Next, a cleaning operation was performed, and in the middle of the cleaning operation (when the ink jet head was separated from the Cap portion and moved to the printing portion), the power supply cable was pulled out and the cleaning operation was forcibly stopped. After the printer was left to stand at room temperature for 2 weeks in this state, the power supply cable was inserted again to turn on the power, and then the number of cycles of cleaning required until normal ejection was achieved was counted. Evaluation was made according to the following criteria, and the results are shown in Tables 1 and 2.

### Evaluation Criteria

A: recovered within 4 cycles of cleaning

B: recovered within 7 cycles of cleaning

C: recovered within 10 cycles of cleaning

D: not recovered even after 10 cycles of cleaning

### 3. 2. 2. Continuous ejection stability-1

Ink jet textile printing machine Monna Lisa Evo Tre 32-180 (manufactured by Seiko Epson Corporation) was filled with the ink jet ink composition of each example, and a roll of 100% silk cloth (twill, 50 to 60 g/m², 140 cm width) having been subjected to pretreatment was set, and continuous printing was performed in a 600×600 D.P.I. 2 Pass mode. The pretreatment of the silk cloth was performed by applying a pretreatment liquid prepared by mixing 1% by mass of sodium alginate, 1% by mass of guar gum, 4% by mass of ammonium sulfate, 10% by mass of urea, and 84% by mass of water to the cloth, squeezing the cloth with a mangle at a pick-up rate of 20%, and drying the cloth. A nozzle check was performed every 100 m of feed of the silk cloth, and it was confirmed whether or not printing was performed normally without missing dots, misalignment, and the like. Evaluation was made according to the following criteria, and the results are shown in Tables 1 and 2.

### Evaluation Criteria

A: printing was normally performed over 1000 m

B: printing was normally performed over 500 m

C: printing was normally performed over 200 m

### D: misdirection occurred within 200 m

### 3. 2. 3. Continuous ejection stability-2

An arbitrary color column (Cyan, Magenta, Yellow, or Photo Black column) of ink jet printer EW-M770T (manufactured by Seiko Epson Corporation) was filled with the ink jet ink composition, printer paper "p" (A4 size) manufactured by Fuji Xerox Co., Ltd. was set, and continuous printing was performed in a plain paper standard mode. A nozzle check was performed every 1000 sheets, and it was confirmed whether or not printing was performed normally without missing dots, misalignment, and the like. Evaluation was made according to the following criteria, and the results are shown in Tables 1 and 2.

### Evaluation Criteria

A: 5000 or more sheets were normally printed

B: 2500 or more sheets were normally printed

C: 1000 or more sheets were normally printed

D: misdirection occurred within 1000 sheets

3. 3. Evaluation Results

The results are shown in Tables 1 and 2.

As can be seen from the results shown in Tables 1 and 2, the ink jet ink compositions according to Examples, which contained a coloring material, an organic solvent, and water and in which the organic solvent contained one or more kinds selected from triethylene glycol monobutyl ether, tetraethylene glycol monobutyl ether, N-hydroxyethyl-2-pyrrolidone and ε-caprolactam, were all excellent in clogging recoverability and also in continuous ejection stability.

In contrast, the ink jet ink compositions according to Comparative Examples which did not satisfy the above-described configuration were inferior in at least one of the clogging recoverability and the continuous ejection stability.

The following contents are derived from the above-described embodiments.

An aspect of the ink jet ink composition is an ink jet ink composition containing a coloring material, an organic solvent, and water, in which the organic solvent contains one or more kinds selected from triethylene glycol monobutyl ether, tetraethylene glycol monobutyl ether, N-hydroxyethyl-2-pyrrolidone, and ε-caprolactam.

In one aspect of the ink jet ink composition, the content of the triethylene glycol monobutyl ether may be 1.0% by mass or more and 20.0% by mass or less with respect to the total amount of the ink jet ink composition.

In either aspect of the ink jet ink composition, the content of the one or more kinds selected from N-hydroxyethyl-2-pyrrolidone and ε-caprolactam may be 5.0% by mass or more and 15.0% by mass or less with respect to the total amount of the ink jet ink composition.

In any aspect of the ink jet ink composition, a mass ratio of the content of the tetraethylene glycol monobutyl ether to the content of the triethylene glycol monobutyl ether may be 5% or more and 15% or less.

In any aspect of the ink jet ink composition, the coloring material may include a water-soluble dye.

In any aspect of the ink jet ink composition, the water-soluble dye may be one or more kinds selected from an acid dye, a direct dye, and, a reactive dye.

In any one aspect of the ink jet ink composition, the content of the water-soluble dye may be 5.0% by mass or more and 20.0% by mass or less with respect to the total amount of the ink jet ink composition.

One aspect of the ink jet recording method includes ejecting the ink jet ink composition of any of the above-described aspects from an ink jet head and attaching the ink jet ink composition to a recording medium.

The present disclosure is not limited to the above-described embodiments, and various modifications are possible. For example, the present disclosure includes a configuration substantially the same as the configurations described in the embodiments, for example, a configuration having the same function, method, and result, or a configuration having the same object and effect. In addition, the present disclosure includes configurations in which non-essential parts of the configurations described in the embodiments are replaced. In addition, the present disclosure includes configurations that achieve the same operational effects or configurations that can achieve the same object as those of the configurations described in the embodiments. In addition, the present disclosure includes a configuration in which a known technique is added to the configurations described in the embodiments.

What is claimed is:

1. An ink jet ink composition, comprising:
a coloring material;
an organic solvent; and
water, wherein
the organic solvent contains one or more kinds selected from triethylene glycol monobutyl ether, tetraethylene glycol monobutyl ether, N-hydroxyethyl-2-pyrrolidone, and ε-caprolactam.

2. The ink jet ink composition according to claim 1, wherein
a content of the triethylene glycol monobutyl ether is 1.0% by mass or more and 20.0% by mass or less with respect to a total amount of the ink jet ink composition.

3. The ink jet ink composition according to claim 1, wherein
a content of the one or more kinds selected from N-hydroxyethyl-2-pyrrolidone and ε-caprolactam is 5.0% by mass or more and 15.0% by mass or less with respect to a total amount of the ink jet ink composition.

4. The ink jet ink composition according to claim 1, wherein
a mass ratio of a content of the tetraethylene glycol monobutyl ether to a content of the triethylene glycol monobutyl ether is 5% or more and 15% or less.

5. The ink jet ink composition according to claim 1, wherein
the coloring material includes a water-soluble dye.

6. The ink jet ink composition according to claim 5, wherein
the water-soluble dye is one or more kinds selected from an acid dye, a direct dye, and, a reactive dye.

7. The ink jet ink composition according to claim 5, wherein
a content of the water-soluble dye is 5.0% by mass or more and 20.0% by mass or less with respect to a total amount of the ink jet ink composition.

8. An ink jet recording method, comprising:
ejecting the ink jet ink composition according to claim 1 from an ink jet head and attaching the ink jet ink composition to a recording medium.
